(19) United States
(12) Patent Application Publication
(10) Pub. No.: US 2018/0096706 A1
(43) Pub. Date: Apr. 5, 2018

(54) IMAGE PROCESSING APPARATUS AND METHOD FOR CONTROLLING THE SAME

(71) Applicant: SAMSUNG ELECTRONICS CO., LTD., Suwon-si (KR)

(72) Inventors: Yeon Ji KIM, Yongin-si (KR); Sarkar DEBASIS, Suwon-si (KR)

(21) Appl. No.: 15/722,100

(22) Filed: Oct. 2, 2017

(30) Foreign Application Priority Data
Oct. 5, 2016 (KR) 10-2016-0128597

(51) Int. Cl. G11B 20/18; G11B 7/1267

(52) U.S. Cl. CPC G11B 20/1833; G11B 7/1267

(57) ABSTRACT

An image processing apparatus, and a method for controlling the image processing apparatus are disclosed. The image processing apparatus includes a data reader comprising data reading circuitry configured to read original data recorded on a storage medium, a signal processor configured to extract an audio stream and a video stream from the original data and to convert a format of the extracted audio stream and a format of the extracted video stream into a predetermined format, a communication module comprising communication circuitry configured to communicate with an external server, and a controller configured to control, when the data reader detects a read error or when the signal processor detects a demuxing error or a conversion error, the communication module to request the external server for at least one of: format-converted audio data and format-converted video data corresponding to a section in which the read error, the demuxing error, or the conversion error is detected.

### CROSS-REFERENCE TO RELATED APPLICATION

This application is based on and claims priority under 35 U.S.C. § 119 to Korean Patent Application No. 10-2016-0128597, filed on Oct. 5, 2016 in the Korean Intellectual Property Office, the disclosure of which is incorporated by reference herein in its entirety.

### BACKGROUND

### 1. Field

The present disclosure relates generally to an image processing apparatus which converts a format of data recorded on a disk and a method for controlling the same.

### 2. Description of Related Art

A digital bridge technology refers to a technique of extracting digital data stored on a disk, converting the extracted data into a specific format, and transferring the format-converted data to another recording medium. As the digital data stored on the disk is converted into a specific format, the data is able to be stored in a recording medium, such as a hard disk drive (HOD) or a flash memory, and is able to be played by a playback apparatus which supports the corresponding format.

During a digital bridge operation, it is determined whether an error has occurred in the format conversion process through an error detection method such as a cyclic redundancy check (CRC). When the error occurs, the user is informed of the occurrence of the error and the digital bridge operation is terminated.

It takes several tens of minutes or longer to perform the digital bridge operation on a single disk. Therefore, in the case where the error occurs during digital bridge operation and the digital bridge operation is performed again from the beginning after the digital bridge operation is completed, the same process is repeatedly performed for the device, and it takes a long time for the user to convert the format of the file, which may cause inconvenience.

### SUMMARY

Therefore, it is an example aspect of the present disclosure to provide an image processing apparatus which does not need to perform the digital bridge operation from the beginning again by fetching the data of the section that cannot be converted due to the error from the server when an error is detected in the process of converting the format of the data recorded on the disk, and a method for controlling the same.

Furthermore, it is an example aspect of the present disclosure to provide an image processing apparatus which can continuously perform the format conversion process after acquiring data from the server and prevent and/or reduce the digital bridge operation from being performed in duplication with respect to the portion where the data is already acquired by appropriately adjusting the position of a read offset based on the type of an error that has occurred, and a method for controlling the same.

Additional aspects of the disclosure will be set forth in part in the description which follows and, in part, will be apparent from the description, or may be learned by practice of the disclosure.

In accordance with an example aspect of the present disclosure, an image processing apparatus may include a data reader comprising data reading circuitry configured to read original data recorded on a storage medium, a signal processor configured to extract an audio stream and a video stream from the original data and to convert a format of the extracted audio stream and a format of the extracted video stream into a predetermined format, a communication module comprising communication circuitry configured to communicate with an external server; and a controller configured to control, when the data reader detects a read error or when the signal processor detects a demuxing error or a conversion error, the communication module to request the server for at least one of: format-converted audio data and format-converted video data corresponding to a section in which the read error, the demuxing error, or the conversion error is detected.

The signal processor may replace data of a section in which the read error, the demuxing error, or the conversion error is detected with at least one of the format-converted audio data and the format-converted video data received from the external server.

The data reader may continue, upon detecting the read error, to read subsequent packets until the data reader finds a packet in which a read error is not detected, and the communication module may receive, upon finding the packet in which a read error is not detected, the format-converted audio data and format-converted video data of the section in which the read error is detected from the external server at once.

The original data may include at least one transport stream comprising a plurality of transport stream packets, and the signal processor may detect the conversion error using a Cyclic Redundancy Check (CRC) test.

The communication module may receive an audio table in which an audio CRC test command to perform the CRC test and transport stream packets of the original data are matched and a video table in which a video CRC test command to perform the CRC test and transport stream packets of the original data are matched from the external server.

The controller may detect the video CRC test command and the audio CRC test command matched with the transport stream packets of a section in which the read error or the demuxing error is detected from the audio table and the video table, and controls the communication module to request the external server for the format-converted audio data corresponding to the detected audio CRC test command and the format-converted video data corresponding to the detected video CRC test command.

The controller may compare a transport stream packet matched with a next command of the detected video CRC test command and a transport stream packet matched with a next command of the detected audio CRC test command to determine a preceding transport stream packet as a read offset position, the data reader may resume the reading of the original data from the determined read offset position.

The signal processor may skip, upon determining that the transport stream packet matched with the next command of the detected video CRC test command precedes the transport stream packet matched with the next command of the detected audio CRC test command, a format conversion for the audio stream until reaching the transport stream packet matched with the next command of the detected audio CRC test command.

The signal processor may skip, upon determining that the transport stream packet matched with the next command of the detected audio CRC test command precedes the transport stream packet matched with the next command of the detected video CRC test command, a format conversion for the video stream until reaching the transport stream packet matched with the next command of the detected video CRC test command.

The signal processor may output a format-converted audio stream and a format-converted video stream, and the image processing apparatus may further include a multiplexer configured to generate an output file including the format-converted audio stream and the format-converted video stream.

In accordance with another example aspect of the present disclosure, a method for controlling an image processing apparatus may include reading original data stored on a storage medium, performing demuxing to extract an audio stream and a video stream from the original data, converting a format of the extracted audio stream and a format of the extracted video stream into a predetermined format, and receiving, when a read error, a demuxing error, or a conversion error is detected, at least one of: format-converted audio data and format-converted video data corresponding to a section in which the read error, the demuxing error, or the conversion error is detected from an external server.

The method for controlling an image processing apparatus may further include replacing data of a section in which the read error, the demuxing error, or the conversion error is detected with the format-converted audio data or the format-converted video data received from the external server.

The method for controlling an image processing apparatus may further include continuing, upon detecting the read error, to read subsequent packets until the data reader finds a packet in which a read error is not detected, and receiving, upon finding a packet in which a read error is not detected, the format-converted audio data and format-converted video data of the section in which the read error is detected from the external server at once.

The original data may include at least one transport stream comprising a plurality of transport stream packets, and the detecting of the conversion error may include detecting the conversion error using a Cyclic Redundancy Check (CRC) test.

The method for controlling an image processing apparatus may further include receiving an audio table in which an audio CRC test command to perform the CRC test and transport stream packets of the original data are matched and a video table in which a video CRC test command to perform the CRC test and transport stream packets of the original data are matched from the external server.

The the receiving of the at least one of the format-converted audio data and the format-converted video data may include detecting the video CRC test command and the audio CRC test command matched with the transport stream packets of a section in which the read error or the demuxing error is detected from the audio table and the video table; and receiving the format-converted audio data corresponding to the detected audio CRC test command and the format-converted video data corresponding to the detected video CRC test command from the external server.

The method for controlling an image processing apparatus may further include comparing a transport stream packet matched with a next command of the detected video CRC test command and a transport stream packet matched with a next command of the detected audio CRC test command to determine a preceding transport stream packet as a read offset position, and resuming the reading of the original data from the determined read offset position.

The method for controlling an image processing apparatus may further include upon determining that the transport stream packet matched with the next command of the detected video CRC test command precedes the transport stream packet matched with the next command of the detected audio CRC test command, performing a format conversion for the video stream and skipping the format conversion for the audio stream until reaching the transport stream packet matched with the next command of the detected audio CRC test command.

The method for controlling an image processing apparatus may further include upon determining that the transport stream packet matched with the next command of the detected audio CRC test command precedes the transport stream packet matched with the next command of the detected video CRC test command, performing a format conversion for the audio stream and skipping the format conversion for the video stream until reaching the transport stream packet matched with the next command of the detected video CRC test command.

The method for controlling an image processing apparatus may further include generating an output file including the format-converted audio stream and the format-converted video stream.

### BRIEF DESCRIPTION OF THE DRAWINGS

These and/or other aspects, features and attendant advantages of the present disclosure will become apparent and more readily appreciated from the following detailed description, taken in conjunction with the accompanying drawings, in which like reference numbers refer to like elements, and wherein:

FIG. 1 is a control block diagram illustrating an example image processing apparatus according to an example embodiment;

FIG. 2 is a diagram illustrating an appearance of an example image processing apparatus according to an example embodiment;

FIG. 3 is a control block diagram illustrating an example image processing apparatus further including components related to the licensing of the digital content according to an example embodiment;

FIG. 4 is a control block diagram illustrating an example image processing apparatus in which the configuration of the format conversion module is embodied according to an example embodiment;

FIG. 5 is a diagram illustrating an example series of processes performed by an image processing apparatus in accordance with an example embodiment;

FIG. 6 is a diagram illustrating an example structure of original data read from a disk;

FIG. 7 is a diagram illustrating an example process of generating a transport stream according to an example embodiment;

FIGS. 8 and 9 are diagrams illustrating an example data replacement operation performed by an image processing apparatus in case an error occurs during format conversion according to an example embodiment;

FIG. 10 is a diagram illustrating an example table in which a unique identifier given to a packet of original data is matched with a video CRC command according to an example embodiment;

FIG. 11 is a diagram illustrating an example table in which a unique identifier given to a packet of original data is matched with an audio CRC command according to an example embodiment;

FIG. 12 is a diagram illustrating an example of replacement of data and adjustment of read offset position according to an example embodiment;

FIG. 13 is a flowchart illustrating an example method of controlling an image processing apparatus according to an example embodiment; and

FIG. 14 is a flowchart illustrating an example method of controlling an image processing apparatus for recovering data when a read error or a demuxing error occurs according to an example embodiment.

### DETAILED DESCRIPTION

Throughout the disclosure, the same reference numerals refer to the same elements. This disclosure may not describe all elements of the embodiments, the general contents in the technical field to which the present disclosure belongs and duplicate contents for each embodiment may not be described in detail. The terms ‘unit, module, member, block’ described in the disclosure may be implemented in software or hardware or any combination thereof, in accordance with the embodiments, a plurality of ‘units, modules, members, blocks’ may be implemented as a component or ‘a unit, a module, a member, a block’ may include a plurality of elements.

Throughout the disclosure, when a part is “connected” to another part, it includes not only a direct connection but also an indirect connection, and an indirect connection includes a connection through a wireless communication network.

When describing that a part “includes” a certain element, it is to be understood that this does not exclude other components, but may include other components, unless specifically stated otherwise.

The singular representation includes plural representations unless the context clearly dictates otherwise.

In each step, the reference numerals are used for convenience of explanation, the reference numerals do not describe the order of each step, and each step can be carried out differently from the specified sequence unless clearly specified in the context.

Hereinafter, an image processing apparatus and a method for controlling the same according to various example embodiments of the present disclosure will be described in greater detail with reference to the accompanying drawings.

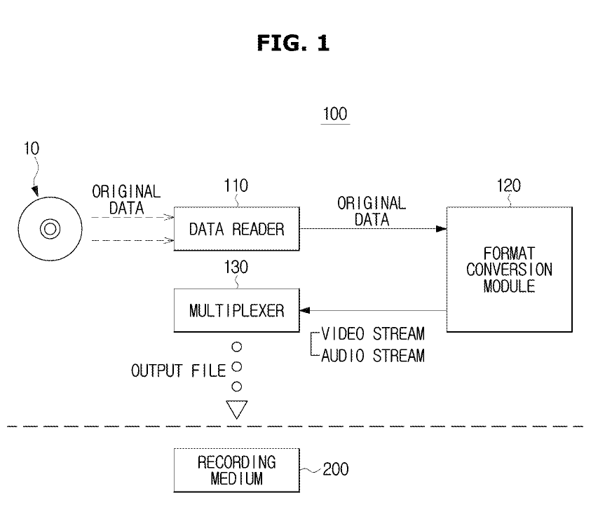

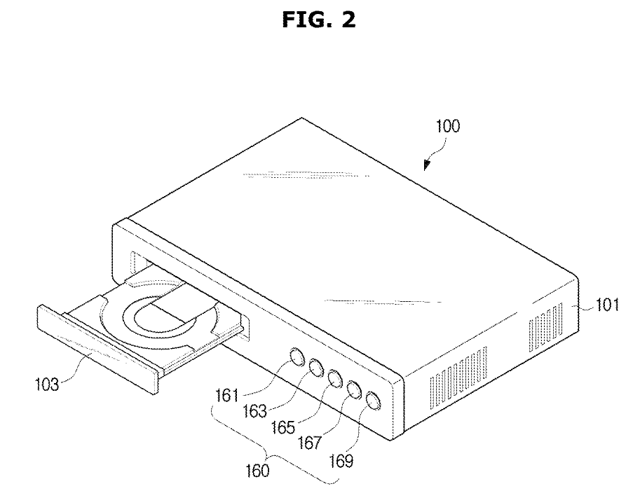

FIG. 1 is a control block diagram illustrating an example image processing apparatus according to an example embodiment, and FIG. 2 is a diagram illustrating an appearance of an example image processing apparatus according to an example embodiment.

Referring to FIG. 1, an image processing apparatus 100 may include a data reader (e.g., including data reading circuitry) 110, a format conversion module (e.g., including format conversion circuitry and/or program elements) 120, and a multiplexer 130. The data reader 110 may read original data recorded on a storage medium 10. The format conversion module 120 may extract a video stream and an audio stream from the original data read from the storage medium 10, decode the extracted video stream and audio stream and output the decoded video stream and audio stream, or convert a format of the extracted video stream and audio stream into a predetermined format and output the format-converted video stream and audio stream. The multiplexer 130 may combine the format-converted video stream and the format-converted audio stream and other data streams into one file and output the combined file.

The output may be implemented in the form of a file that can be stored on a recording medium 200 such as, for example, and without limitation, a hard disk drive (HDD) and a flash memory, or the like.

The storage medium 10 may be, for example, and without limitation, an optical disk such as a compact disk (CD), a digital video disk (DVD), and a Blu-ray disk (BD). For convenience of description and better understanding of the present disclosure, the following embodiment may assume that the storage medium 10 is a disk.

The image processing apparatus 100 is an apparatus capable of reading data stored on the storage medium 10 and performing various processes on the read data. For example, the image processing apparatus 100 may be implemented as a playback apparatus such as a DVD player and a Blu-ray player. Furthermore, the image processing apparatus 100 may be implemented, for example, and without limitation, as an electronic device such as a PC, a TV, a mobile phone, a tablet PC, and a wearable device, or the like, capable of reading the data stored on the storage medium 10. For convenience of description and better understanding of the present disclosure, the following embodiment may assume that the storage medium 10 is the Blu-ray disk (BD) capable of storing the data having High Definition (HD) or Ultra High Definition (UHD) resolution.

For example, the original data may be stored in MPEG-2 Transport Stream (M2TS) format on the storage medium 10. A transport stream comprises a plurality of packets each having a predetermined length (for example, 188 bytes) and is a stream in which audio data and video data are mixed.

The data reader 110 may include various data reading circuitry and read the original data stored in M2TS format from the storage medium 10, and then the format conversion module 120 may perform demuxing and format conversion on the read data and output the format-converted audio stream and video stream. The specific operation of the format conversion module 120 will be described in greater detail below.

The multiplexer 130 may combine the format-converted audio stream and the format-converted video stream into one file and output the combined file. The multiplexer 130 may include a data stream including other information required for outputting the multimedia contents, for example, caption information, in the output file.

The format conversion module 120 may include various format conversion circuitry and/or program elements and converts the format of the original data in order to record the original data stored on the storage medium 10 to the recoding medium 200. Therefore, the format conversion module 120 may perform an operation of converting the format of the original data into a file format suitable for the recording medium 200 or an operation of encrypting the original data. A series of processes required to convert a format of digital content stored on the storage medium 10 or such a function may, for example, be referred to as a digital bridge.

The user can freely move and store digital content with superior resolution, such as HD and UHD, from A device to B device (Device to Device) using the digital bridge technology, and then view the digital content through device B.

When the image processing apparatus 100 is implemented as the playback apparatus such as the Blu-ray player, as illustrated in FIG. 2, the image processing apparatus 100 may further include an inputter (e.g., input circuitry) 160 for receiving a control command from a user. The inputter 160 may be provided in the main body 101 and may include various input circuitry, such as, for example, and without limitation, a switch, a touch pad, and a jog shuttle, or the like. Alternatively, the inputter 160 may include various input circuitry provided in a remote controller.

The inputter 160 may include a format conversion button 161 for receiving a selection of a digital bridge operation from the user. When the user inserts the storage medium 10 in which the digital content desired to be format-converted is stored into the main body 101 and selects the format conversion button 161, the format conversion module 120 may convert the format of the digital content stored on the storage medium 10 according to the process to be described later.

The inputter 160 may further include a power button 163 for receiving a command to turn on/off the power, a loading button 165 for receiving a command to load/unload the tray 103, a playback button 167 for receiving a command to play the digital content stored on the storage medium 10, and a pause button 169 receiving a command to pause the digital content being played. However, the embodiment of the image processing apparatus 100 is not limited to the above example, and it is also possible to omit some buttons or add buttons having other functions in the above example.

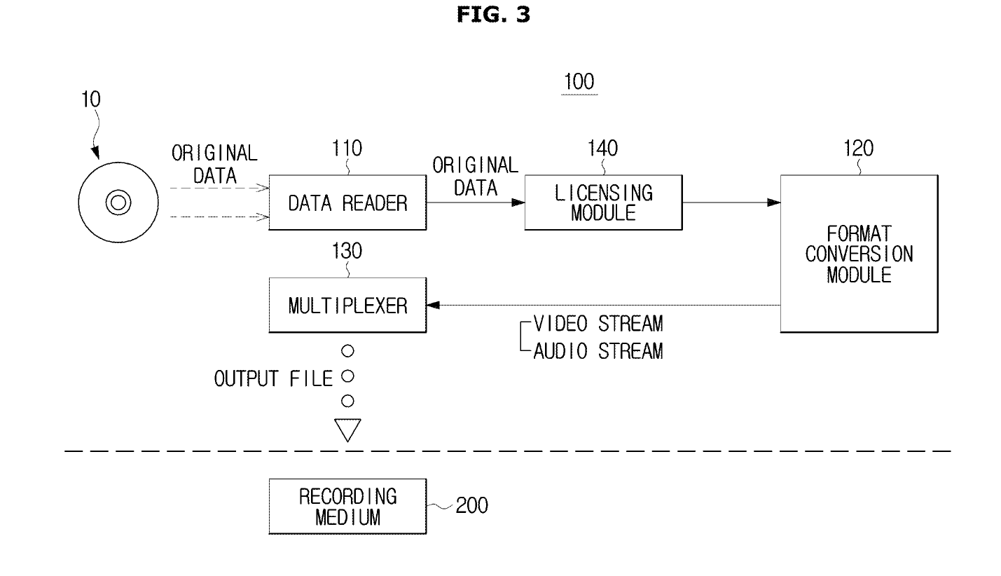

FIG. 3 is a control block diagram illustrating an example image processing apparatus further including components related to the licensing of the digital content according to an example embodiment;

Most digital content that has recently been distributed is protected by Digital Rights Management (DRM). The DRM may refer, for example, to all technologies for controlling the use of the digital content and preventing piracy and illegal distribution. The user must obtain a license distributed by the copyright holder of the digital content to use the digital content protected by the DRM.

Referring to FIG. 3, the image processing apparatus 100 may further include a licensing module (e.g., including circuitry and/or program elements) 140 for releasing the DRM applied to the storage medium 10. The licensing module 104 may perform operations that depend on the type of the DMR applied to the storage medium 10.

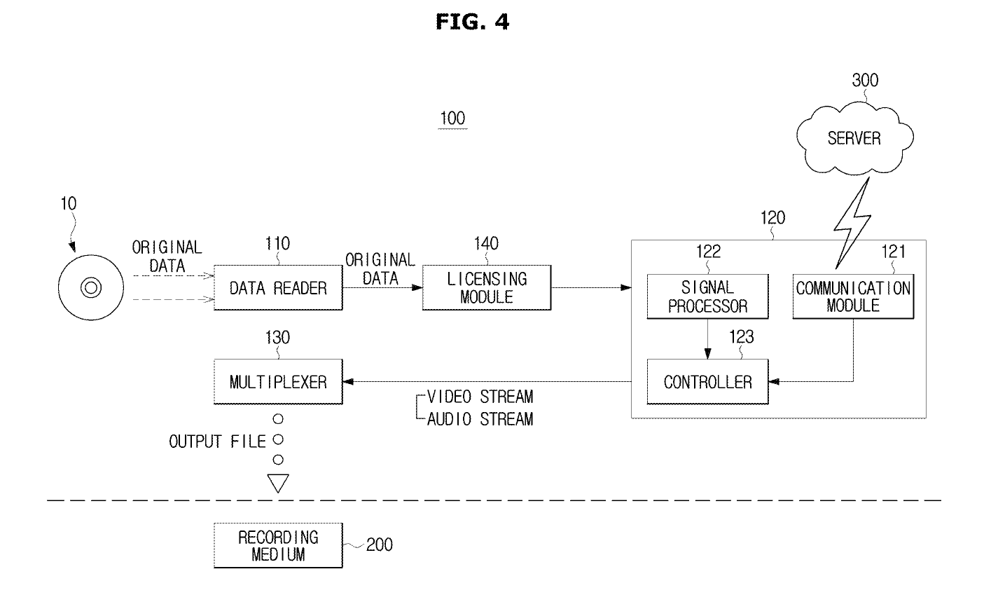

For example, a standard of the DRM for HD DVD and Blu-ray disks, which provide the digital content having high-resolution, corresponds to the Advanced Access Content System (AACS). Therefore, when the image processing apparatus 10 processes the digital content stored the Blu-ray disk, the licensing module 140 may release the DRM applied to the Blu-ray disk using decryption key of the AACS received from the server 300 (FIG. 4) managed by a provider of the digital content.

When the licensing module 140 releases the DRM applied to the storage medium 10, the original data read from the storage medium 10 by the data reader 110 is transferred to the format conversion module 120, and then the format conversion module 120 converts the format of the original data into a predetermined format according to processes to be described later.

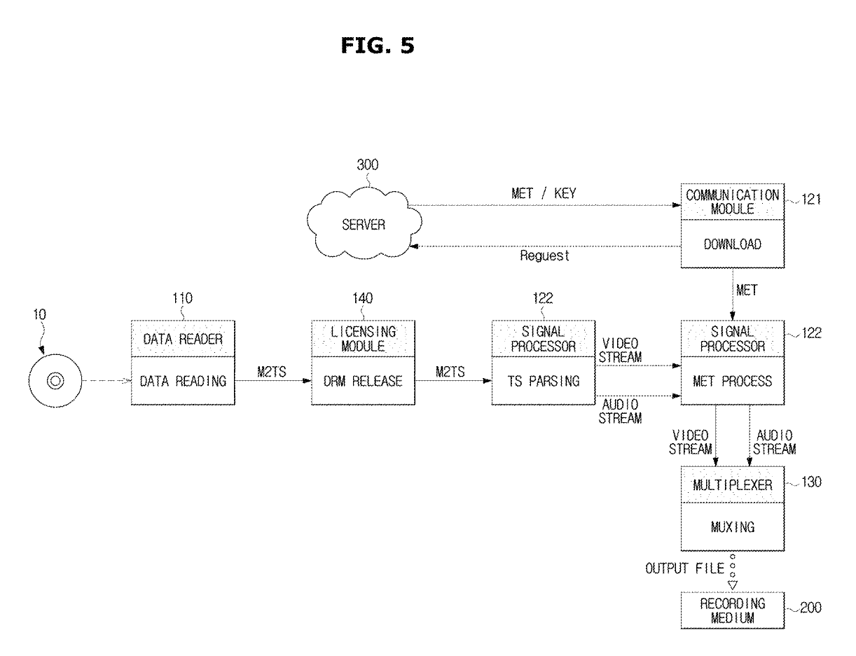

FIG. 4 is a control block diagram illustrating an example image processing apparatus in which the configuration of the format conversion module is embodied according to an example embodiment, and FIG. 5 is a diagram illustrating a series of example processes performed by an image processing apparatus according to an example embodiment.

Referring to FIG. 4, the format conversion module 120 may include a communication module (e.g., including communication circuitry) 121 for communicating with an external server 300 and receiving data needed for the format conversion, a signal processor (e.g., including signal processing circuitry) 122 for extracting an elementary stream such as the audio stream and the video stream from the original data and converting the format of the audio stream and the video stream into the predetermined format, and a controller (e.g., including processing circuitry) 123 for controlling the communication module 121 to request information related to a section in which an error occurs when the error occurs. The server 300 may be managed by the provider of the digital content.

The communication module 121 may include various communication circuitry that enable communication with the external server 300. For example, the communication module 121 may include, without limitation, at least one of a wired communication module and a wireless communication module.

The wired communication module may include not only various wired communication modules such as a Local Area Network (LAN) module; a Wide Area Network (WAN) module, and a Value Added Network (VAN) module, but also various cable communication modules such as a High Definition Multimedia Interface (HDMI), a Digital Visual Interface (DVI), a recommended standard 232 (RS-232), a power line communication, a plain old telephone service (POTS) or the like.

The wireless communication module may include various modules that support wireless communication methods such as a Global System for Mobile Communication (GSM), a Code Division Multiple Access (CDMA), a Wideband Code Division Multiple Access (WCDMA), Time Division Multiple Access (TDMA), Long Term Evolution (LTE) and the like as well as a Wifi module and a Wireless broadband module.

The wireless communication module may include a wireless communication interface including an antenna and a transceiver. The wireless communication module may further include a signal conversion module for modulating a digital control signal into an analog wireless signal or demodulating the analog wireless signal into a digital signal.

The signal processor 122 may include various signal processing circuitry to perform the demuxing in software or hardware. For convenience of description and better understanding of the present disclosure, the following example embodiment may assume that the demuxing is performed in software, though the example embodiment is not limited thereto.

The signal processor 122 may convert the format of the audio stream and the video stream.

The controller 123 may include various processing circuitry to control the overall operation related to the digital bridge. The controller 123 may control the communication module 121 to request the data required for the digital bridge operation at the server 300 and to receive the data from the server 300. As will be described in greater detail below, the controller 123 may adjust the read offset position of the data reader 11. Detailed operations of the controller 123 will be described in greater detail below.

The signal processor 122 and the controller 123 may include a memory storing a program for performing the above-described operations and the operations to be described later and a processor for executing the program stored in the memory. The signal processor 122 and the controller 123 may share the processor and/or the memory, or may use separate processors and/or memories, respectively. In the latter case, they can be integrated on a single chip or physically separated. In other words, as long as it is possible to perform the entire operation for extracting the elementary stream and converting the file format, there is no restriction on the design method for implementing them.

Hereinafter, with reference to FIG. 5, a series of processes in which the image processing apparatus 100 converts the format of the digital content stored on the storage medium 10 will be described.

When the storage medium 10 on which the digital content is recorded is inserted into the image processing apparatus 100 and the user selects the format conversion button 161, the controller 123 controls the communication module 121 to transmit a signal requesting the server 300 for necessary information. Here, the necessary information may include information necessary for the format conversion and key information necessary for the DRM release.

The data reader 110 reads the original data stored on the storage medium 10. This embodiment may assume that the original data stored on the storage medium 10 has the M2TS format.

When the DRM is applied to the storage medium 10, the data read by the data reader 110 corresponds to M2TS that cannot perform the format conversion. Therefore, the licensing module 140 may release the DRM applied to the storage medium 10 using the decryption key received from the server 300 via the communication module 121.

When the original data released from the DRM is transferred to the format conversion module 120, the signal processor 122 performs demuxing for extracting the audio stream and the video stream from the original data released from the DRM. The extracting an audio stream and a video stream from a transport stream (TS) is referred to as a TS Parsing.

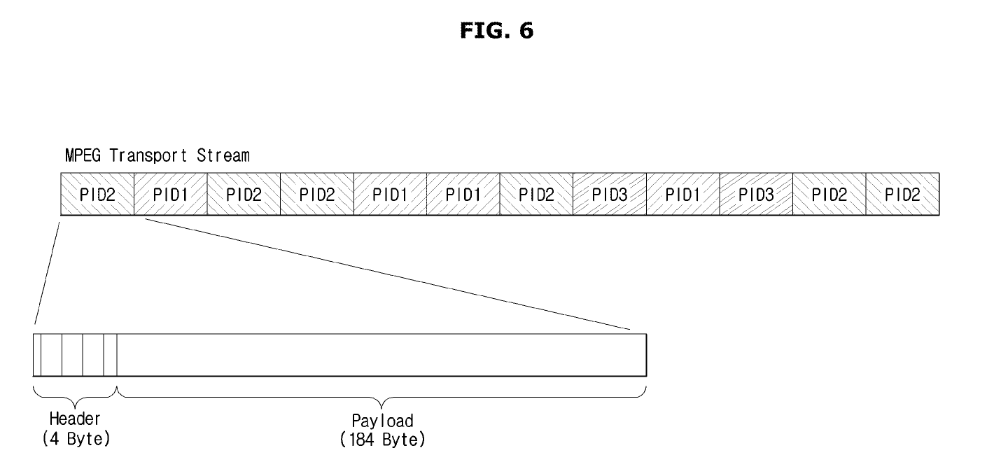

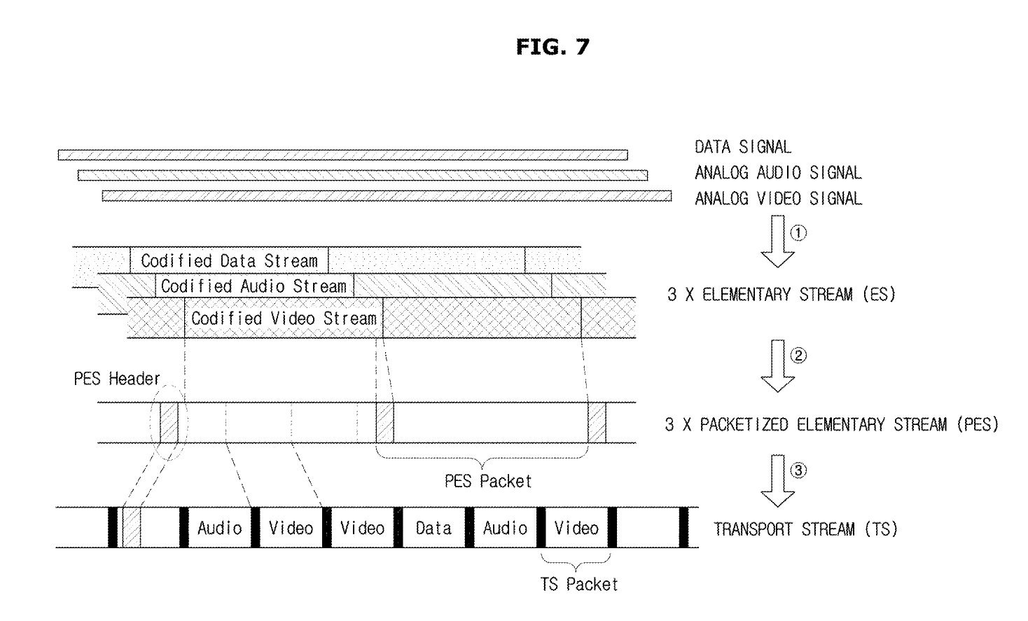

FIG. 6 is a diagram schematically illustrating an example structure of original data read from a disk, and FIG. 7 is a diagram illustrating an example process of generating a transport stream according to an example embodiment.

Referring to the example of FIG. 6, the original data having the form of a transport stream read from the disk may comprise a plurality of packets each having a length of 188 bytes. Each packet may contain a header with a length of 4 bytes and a payload with a length of 184 bytes. The header may include sync byte information and a packet ID (PID) and so on.

Each packet may either video data, audio data, or other data and be identified by the packet ID (PID). The packets with the same PID belong to the same elementary stream. For example, all packets having PID 1 belong to the audio elementary stream, all packets having PID 2 belong to the video elementary stream, and all packets having PID 3 belong to the data elementary stream. The data belonging to the data elementary stream may include data other than the audio data and the video data among data constituting digital content, for example, a subtitle. Such a transport stream may be generated by the following processes.

Referring to FIG. 7, an analog audio signal, an analog video signal and data signal are encoded using the MPEG-2 compression technology to generate three elementary streams: an audio elementary stream, a video elementary stream, and a data elementary stream (\textcircled{1}). The audio elementary stream corresponds to a set of consecutive audio tracks, and the video elementary stream corresponds to a set of consecutive video frames.

The plurality of elementary streams are packetized respectively to generate a packetized elementary streams (PES) for multiplexing (\textcircled{2}). Each packetized elementary stream (PES) is once again packetized to generate a transport stream, and the data of each stream is stored in transport stream packets (TS packets) comprising one transport stream (\textcircled{3}). Each transport stream packet has a length of 188 bytes shorter than the length of the PES packet. Thus, a PES packet may be split into a plurality of transport stream packets.

As illustrated in FIG. 6 and FIG. 7, since the audio data and the video data are mixed in the original data read from the storage medium 10, the signal processor 122 performs a parsing or de-multiplexing operation to extract the audio stream and the video stream from the transport stream. In addition, when a data stream is included in the transport stream, the signal processor 122 may extract the data stream.

Referring back to FIG. 5, the signal processor 122 may convert the format of the audio stream and the format of the video stream into a predetermined format using the information required for the format conversion received from the server 300.

This format conversion can be executed based on a command indicating which task should be performed on certain data, and the command information can be provided in a table form. Thus, information required for the format conversion can be referred to as a Media Extraction Table (MET). In the following embodiments, for convenience of description, information used for the format conversion will be referred to as MET, but the embodiment of the image processing apparatus 100 is not limited thereto. Therefore, regardless of the name used to refer to the information used for the format conversion, those corresponding to the above-described or later-described contents can be included in the scope of the present disclosure.

The MET process may be performed separately for each of the audio stream and the video stream. Thus, the communication module 121 may receive the audio MET and the video MET from the server 300, respectively.

As described above, the format of the file to be converted may be a format designated for the recording medium 200 on which the digital content recorded in the storage medium 10 is transferred and recorded. Here, the recording medium 200 may be implemented as a memory capable of a writing function such as a hard disk drive, an optical disk drive, a flash memory, and the like.

For example, the format designated for the recording medium 200 may be the secure content storage association (SCSA) format. When the digital content is converted into the SCSA format and recorded in the recording medium 200, it can be reproduced through an SCSA-enabled device such as a TV, a personal computer, a laptop computer, a Blu-ray player, a tablet PC, a mobile phone, a game console and so on.

The signal processor 122 converts the format of the audio stream and the video stream into a predetermined format based on the MET process and transmits the format-converted audio stream and the format-converted video stream to the multiplexer 130, and then the multiplexer 130 performs muxing to combine the format-converted audio stream and the format-converted video stream into one file. The file output by the multiplexer 130 may further include additional data such as a subtitle stream as well as the audio stream and the video stream.

The output file can be transferred and recorded in the recording medium 200. For example, when a user connects an external recording medium such as a USB flash drive, a Secure Digital (SD) card, or a solid state drive (SSD) to the image processing apparatus 100, the format-converted output file can be transferred to the recording medium and recorded on the recording medium 200.

In order to complete the digital bridge operation for a single disk, it takes at least several tens of minutes to read all the data stored on the disk. Since the digital bridge operation takes a long time, an error detection operation can be performed to check whether the data conversion is normally performed in the middle of the operation.

For example, the signal processor 122 may perform a Cyclic Redundancy Check (CRC) test to detect an error. The MET file received from the server 300 also includes a CRC test command. The signal processor 122 may calculate the CRC while performing the MET process for format conversion, and when the CRC test command is encountered, determine whether or not the calculated CRC and the reference CRC stored in the MET coincide with each other. The signal processor 122 may determine that the error does not occur when the calculated CRC and the reference CRC coincide with each other, and determine that the error has occurred when the calculated CRC and the reference CRC do not coincide with each other. The image processing apparatus 100 in accordance with an embodiment does not necessarily have to detect an error using the CRC test. However, for a specific explanation, in the following embodiment, it is assumed that the CRC test is used to detect the error.

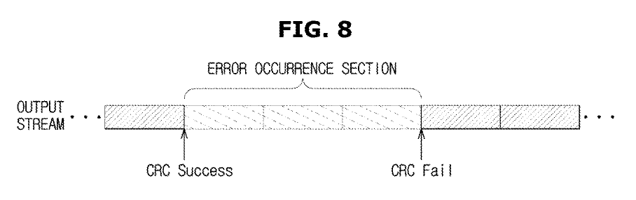

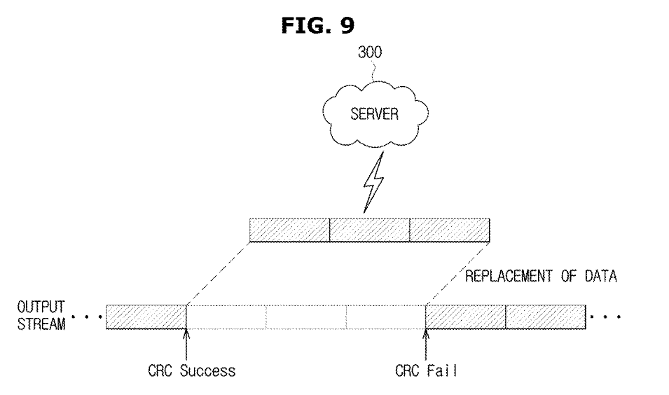

FIGS. 8 and 9 are diagrams illustrating an example data replacement operation performed by an image processing apparatus in case an error occurs during format conversion according to an example embodiment.

Conventionally, when a CRC error, a read error, a demuxing error, or the like occurs, the image processing apparatus notifies the user of the occurrence of an error and stops the digital bridge operation. For example, if there is a read error due to a foreign substance on the disk, the user has to remove the foreign substance and insert it into the image processing apparatus again to perform the digital bridge operation again from the beginning. If there is a physical damage to the disk, the digital bridge operation cannot be performed on the disk.

On the other hand, the image processing apparatus 100 in accordance with an example embodiment of the present disclosure may perform the digital bridge operation on the disk having physical damage by fetching data corresponding to an error occurrence section from the server 300. In addition, since the image processing apparatus does not need to perform the digital bridge operation from the beginning after an error has occurred and been detected, the same operation need not be repeatedly performed. Hereinafter, various example embodiments will be described in greater detail with reference to the drawings.

The server 300 may store the digital content stored on the storage medium 10 in a format designated for the recording medium 200. Furthermore, the server 300 may store format-converted data that matches the CRC test command for each of the audio and video.

As described above, the signal processor 122 may calculate the CRC while performing the MET process according to the command stored in the MET, perform the CRC test at the point where the CRC test command is encountered, and determine that the CRC error has occurred when the test result fails. In this case, as illustrated in FIG. 8, a section from the point at which the CRC test last succeeded to the point at which the CRC test failed may be estimated as an error occurrence section. Furthermore, as illustrated in FIG. 9, the data corresponding to the error occurrence section may be downloaded from the server 300 and replaced with the data downloaded data.

In order to estimate or determine the error occurrence section, the signal processor 122 may store the corresponding point when the CRC test is successful. The position of each packet comprising the data stream may be referred to as an offset. The position of each packet may be referred to as a read offset when reading data, or as a write offset when writing data.

The amount of data to be downloaded from the server 300 can be calculated (determined) from the MET command. The calculated amount of data may be downloaded from the server 300, and then the data from the offset at which the CRC test last succeeded to the offset at which the CRC test failed may be replaced with the format-converted data downloaded from the server 300.

The CRC test can also be performed for each of the audio stream and the video stream like the MET process. Therefore, the CRC command table included in the MET file may also be provided for each of audio and video.

However, the example embodiments of the present disclosure are not so limited, and in some cases it is also possible that the CRC test is performed on the audio stream and the video stream together.

The operation of fetching the format-converted data from the server 300 and the operation of adjusting the read offset after data replacement may vary depending on the type of the error. This will be described in greater detail below.

The errors that may occur during the digital bridge operation may include \textcircled{1} a read error indicating that the data cannot be read from the storage medium 10 \textcircled{2} a demuxing error indicating that the data is read from the storage medium 10 but it is impossible to extract the elementary stream from the read data, and \textcircled{3} a CRC error that may occur while performing the MET process after reading the data from the storage medium 10 and extracting the elementary stream, that is, the CRC error indicating that data corruption occurred in the packet area of the elementary stream.

Since \textcircled{1} and \textcircled{2} correspond to the case where the elementary stream cannot be extracted, the data replacement and the digital bridge operation can be resumed by using the matching relation between each transport stream packet constituting the M2TS and the CRC test command.

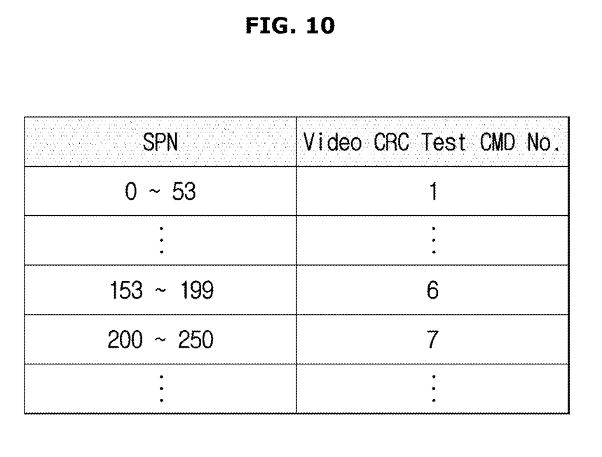

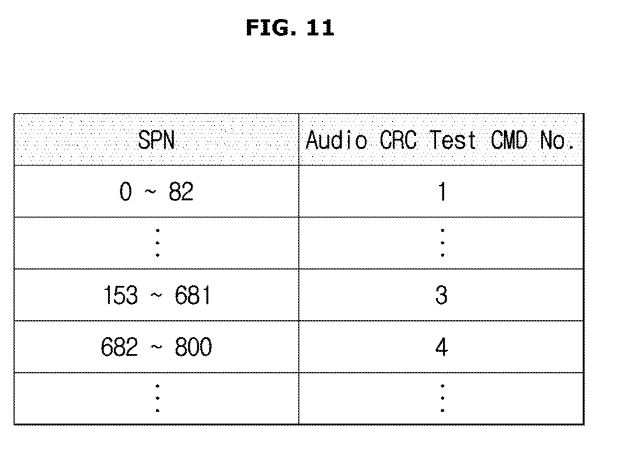

FIG. 10 is a diagram illustrating an example table in which a unique identifier given to a packet of original data is matched with a video CRC command, and FIG. 11 is a diagram illustrating an example table in which a unique identifier given to a packet of original data is matched with an audio CRC command according to an example embodiment.

According to an example embodiment of the present disclosure, a unique identifier can be given to each of the packets of the M2TS. However, the unique identifier is an identifier that is distinguishable from a PID indicating in which elementary stream the packet is included, and is capable of distinguishing each of a plurality of packets of the M2TS.

For example, as illustrated in FIGS. 10 and 11, the unique identifier may be a number sequentially assigned to each packet. This will be referred to as a source packet number (SPN). However, the example embodiments of the present disclosure are not limited to this, and it is also possible to use another kind of identifier such as an alphabet, if it is possible to distinguish each transport stream packet and to know temporal relation with other transport stream packets.

The source packet numbers of the M2TS and the CRC test command numbers may be matched and the matching relationship between the two information may be stored in the server 300 in the form of a table. Since the CRC test is performed for the audio and the video, respectively, a matching table between the source packet numbers and the CRC test command numbers may also be provided for the audio and the video, respectively.

For example, the server 300 may store an audio table in which an audio CRC test command and a transport stream packet are matched, and a video table in which a video CRC test command and a transport stream packet are matched, and the audio table and the video table can be downloaded from the server 300 to the image processing apparatus 100.

According to the example of FIG. 10, the transport stream packets with source packet number 0 to 53, in other words, the transport stream packets 0 to 53 are matched with the video CRC command 1, and the transport stream packets with source packet number 153 to 199, in other words, the transport stream packets 153 to 199 are matched with the video CRC command 6. Further, the transport stream packets 200 to 250 are matched with the video CRC command 7.

According to the example of FIG. 11, the transport stream packets 0 to 53 are matched with the audio CRC command 1, and the transport stream packets 153 to 681 are matched with the audio CRC command 3. Further, the transport stream packets 682 to 800 are matched with the audio CRC command 4.

The tables of FIGS. 10 and 11 are arbitrarily set for convenience of description and better understanding of the present disclosure, and the matching relation between the packet number and the CRC command number may be changed based on the digital content stored in the disk.

For example, when the read error occurs in which the data is not read properly due to physical damage or foreign substance on the storage medium 10, the data reader 110 may transmit information on the read error occurrence position indicating the position of the transport stream packet in which the read error has occurred to the controller 123, together with the occurrence of the read error. When the data reader 110 reads the data recorded on the storage medium 10, a plurality of packet units may be read at once. Thus, the read error occurrence position may be a section including a plurality of transport stream packets.

The controller 123 may search the CRC test command corresponding to the read error occurrence position with reference to the tables of FIGS. 10 and 11.

The server 300 may store output stream data corresponding to the CRC test command, the format-converted audio data, and the format-converted video data. The communication module 121 may request the corresponding data to the server 300, and when receiving the data, the signal processor 122 may replace the data of the section in which the CRC error occurs with the data received from the server 300.

When the CRC error section is long, the amount of communication with the server 300 may be excessively increased. Thus, the data reader 110 may continue to read the data stored on the storage medium 10 until it finds a packet in which a read error does not occur. When the packet in which the read error does not occur is found, the data reader 110 may request the output file data corresponding to packets preceding the found packet in which the read error does not occur to the server 300 at once and perform replacement.

Likewise, the above-described data replacement operation may be performed for each of the audio data and the video data.

After replacing the data, the operation of reading data from the storage medium 10 is resumed. Since the audio data and the video data are mixed in the transport stream, when the data reading operation is resumed, the read offset position should be appropriately adjusted as follows.

The position of the next packet with respect to the audio is compared with the position of the next packet with respect to the video to set the position of the preceding packet to the read offset position at which the reading operation is resumed. The reading operation is resumed from the set position, and the format conversion operation is performed on the data having the next packet, which is determined to be earlier as a result of the comparison, and the data is written on the output stream, and the format conversion operation on the data having the next packet, which is determined to be late, is skipped until reaching the position of the next packet, which is determined to be late as a result of the comparison.

For example, when the position of the next packet with respect to the video precedes the position of the next packet with respect to the audio, that is, when the packet number of the next packet with respect to the video is smaller than the packet number of the next packet with respect to the audio, the format conversion operation is performed only for the video, and the corresponding operation for the audio is skipped until the packet number to be read next is reached.

As described above, it is possible to prevent and/or reduce problems such as missing necessary data, overwriting on data that has already been replaced, and the like by adjusting the read offset position of the audio and the video when resuming the digital bridge operation after the data replacement.

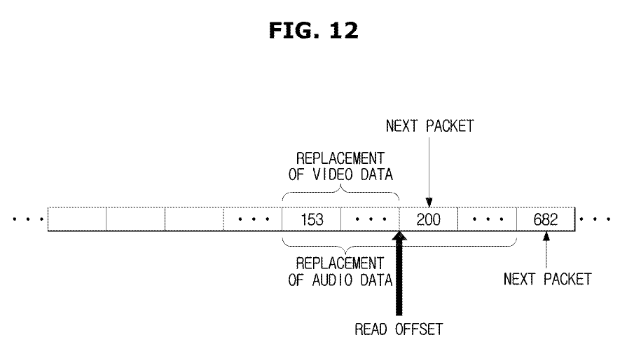

FIG. 12 is a diagram illustrating an example of replacement of data and adjustment of read offset position according to an example embodiment.

Hereinafter, a specific embodiment will be described with reference to the tables of FIGS. 10 and 11, and FIG. 12 together. In this embodiment, it is assumed that the read error occurs in transport stream packets 153 to 199.

The transport stream packets 153 to 199 are matched to the video CRC test command 6 according to the table of FIG. 10, and are matched to the audio CRC test command 3 according to the table of FIG. 11.

The controller 123 controls the communication module 121 to download the output stream data corresponding to the video CRC test command No. 6, that is, the format-converted video data, from the server 300. The signal processor 122 replaces the section of the output stream corresponding to the video CRC test command 6 with the format-converted video data downloaded from the server 300.

The controller 123 controls the communication module 121 to download the output stream data corresponding to the audio CRC test command 3, that is, the format-converted audio data, from the server 300. The signal processor 122 replaces the section of the output stream corresponding to the audio CRC test command 3 with the format-converted audio data downloaded from the server 300.

As a result, the data corresponding to transport stream packets 153 to 199 may be replaced with the format-converted video data, and the data corresponding to transport stream packets 153 to 681 may be replaced with the format-converted audio data.

After replacing of the data, the data reader 110 must read the original data again from the storage medium 10. The data reader 110 may read from the transport stream packet 200 with regard to the video stream, and read from the transport stream packet 682 with regard to the audio stream. That is, the number of the next transport stream packet for the video is 200, and the number of the next transport stream packet for the audio is 682.

Since the transport stream packet 200 precedes the transport stream packet 682, the data reader 110 may read the data from the transport stream packet 200. That is, the controller 123 may control the data reader 110 to move the read offset position to the transport stream packet 200, thereby preventing the data from being missed. The data read by the data reader 110 may be used to generate the output stream after the demuxing and the format conversion.

In the audio stream, the data corresponding to the section from a transport stream packet 153 to a transport stream packet 681 has already been replaced. Therefore, the data corresponding to section from the transport stream packet 200 to the transport stream packet 681 is used only for generating the video output stream and not for generating the audio output stream.

On the other hand, in the case \textcircled{3} in which the error has occurred during the execution of the MET process even though the data is read from the disc and the elementary stream is extracted from the read data, the signal processor 122 may receive the output stream corresponding to the section from the point at which the CRC test last succeeded to the point at which the CRC test failed and replace the data of the section with the received data, and then perform the MET process again from the point of a next elementary stream at which the CRC test failed. Since the MET process is already performed for each elementary stream of the audio and the video, there is no need to adjust the read offset position of the transport stream as in the cases \textcircled{1} and \textcircled{2}.

Hereinafter, a method for controlling an image processing apparatus in accordance with an embodiment will be described. This method may be applied to the image processing apparatus 100 according to the above-described embodiment. Thus, the contents described above with reference to FIGS. 1 to 12 may also be applied to the method for controlling an image processing apparatus in accordance with an embodiment to be described later.

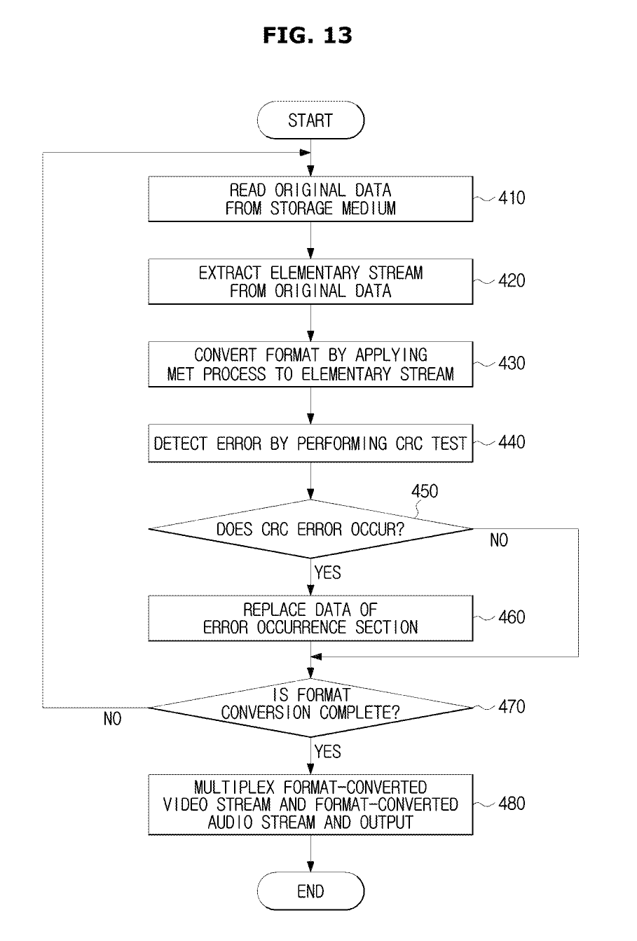

FIG. 13 is a flowchart illustrating an example method of controlling an image processing apparatus according to an example embodiment.

Referring to FIG. 13, first, the original data is read from the storage medium 10 (410). In this embodiment, it is assumed that the original data has the M2TS format. In case the DRM is applied to the storage medium 10, the DMR may be released using a key required to release the DRM received from the server 300.

The elementary stream is extracted from the original data (420). As described above with reference to the FIG. 7, the audio data and the video data are mixed in the original data having the M2TS format. Therefore, the signal processor 122 extracts the audio elementary stream and the video elementary stream from the original data by performing demuxing on the original data.

The signal processor 122 converts the format of the audio stream and the format of the video stream by applying the MET process (430). The MET process is an example of a process used to convert the format of the data. When the user selects the digital bridge operation, the communication module 121 receives the MET file containing information on the MET process from the server 300. The format of the file converted by the signal processor 122 may be a format designated for the recording medium 200 on which the digital content is transferred and stored. For example, the signal processor 122 may convert the format of the audio stream and the format of the video stream to the SCSA format.

The signal processor 122 performs the error detection operation using the CRC test to check whether the MET process is normally performed during the format conversion (440). The CRC test corresponds to an example of the error detection operation, and the MET file received from the server 300 also includes a CRC test command. The signal processor 122 calculates the CRC while performing the MET process for the format conversion, and when the CRC test command is encountered, determines whether or not the calculated CRC and the reference CRC stored in the MET coincide with each other. The signal processor 122 determines that the error does not occur when the calculated CRC and the reference CRC coincide with each other (CRC test success), and determines that the error has occurred when the calculated CRC and the reference CRC do not coincide with each other (CRC test failure).

Upon determining that the CRC error has occurred (“YES” in operation 450), the signal processor 122 replaces the data corresponding to the error occurrence section with the data downloaded from the server 300 (460). The signal processor 122 estimates the section from the point at which the CRC test last succeeded to the point at which the CRC test failed as the error occurrence section and receives the data corresponding to the error occurrence section from the server 300 through the communication module 121.

The signal processor 122 determines whether the format conversion has been completed (470). Upon determining that the format conversion has not been completed (“No” in operation 470), the above-described operations 410 to 460 are repeated. On the other hand, upon determining that the format conversion has been completed (“YES” in operation 470), the signal processor 122 transmits the format-converted video stream and the format-converted audio steam to the multiplexer 130, and the multiplexer 130 combines the format-converted audio stream and the video stream into one file and outputs it (480).

When the user connects the external recording medium 200 such as a USB flash drive, a Secure Digital (SD) card and a Solid State Drive (SSD) to the image processing apparatus 100, the format-converted output file may be transferred to the recording medium 200.

Hereinafter, in the case where the elementary stream cannot be extracted due to occurrence of the read error or the demuxing error, a method for replacing the data will be described in greater detail.

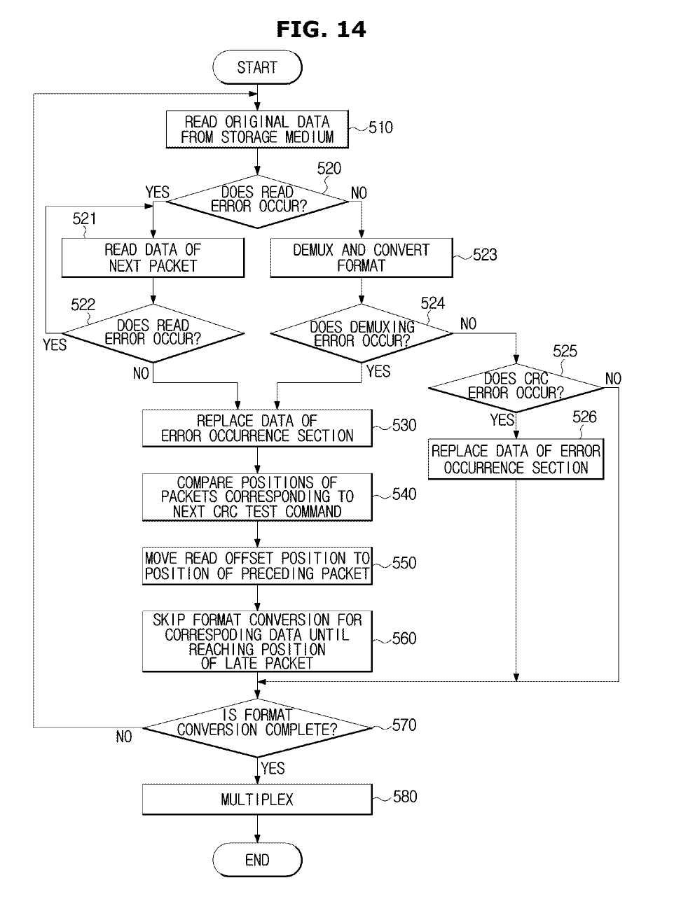

FIG. 14 is a flowchart illustrating an example method of controlling an image processing apparatus for recovering data when a read error or a demuxing error occurs according to an example embodiment.

Referring to FIG. 14, the original data is read from the storage medium 10 (510). As described above, it is assumed that the original data has the M2TS format.

The data reader 110 may read the data stored on the storage medium 10 by considering a plurality of packets as one unit. A read error may occur when data cannot be read from the storage medium 10, such as when foreign substances are present on the storage medium 10 or when physical damage to the storage medium 10 occurs.

In the case where the read error has occurred (“YES” in operation 520), the data reader 110 reads the next packet of the packet in which the read error occurred (521) and continues to read the data of subsequent packets until it finds a packet in which a read error does not occur (522). Upon finding the packet in which a read error does not occur (“NO” in operation 522), the signal processor 122 replaces the data of the error occurrence section with the data downloaded from the server (530). Specifically, the CRC test command corresponding to the packet in which the read error has not occurred may be detected in the table as shown in the example of FIGS. 10 and 11 described above. The transport stream packets matched with the CRC test commands before the detected CRC test command cannot be extracted as the elementary stream, so that the corresponding output stream cannot be obtained. Therefore, the output stream data corresponding to the CRC test commands before the occurrence of the read error may be downloaded from the server 300 and replaced with the data of the error occurrence section. Replacement of the data may be performed for each of the audio stream and the video stream.

Meanwhile, in the case where the read error has not occurred (“NO” in operation 520), the format conversion module 120 performs demuxing to extract the audio stream and the video stream from the original data, and performs the MET process to convert the format of the extracted audio stream and a format of the extracted video stream into the predetermined format (523).

In the case where the demuxing error has occurred (“YES” in operation 524), since the elementary stream cannot be extracted as in the case where the read error occurs, the data of the error occurrence section can be replaced by the method described above (530).

In the case where the demuxing error has not occurred (“NO” in operation 524), as described above with reference to the FIG. 13, the controller 123 performs the CRC test and determines whether a CRC error has occurred (525). Upon determining that the CRC error has occurred (“YES” in operation 525), the signal processor 122 replaces the data corresponding to the CRC command with the data downloaded from the server 300 (526).

When the elementary stream cannot be extracted due to the read error or the demuxing error, the process of adjusting the position of the read offset after replacing the data is as follows.

The controller 123 compares the positions of the packets corresponding to the next CRC test command (540) and moves the position of the read offset to the position of the preceding packet (550). Specifically, the controller 123 compares the position of the next packet with respect to the audio and the position of the next packet with respect to the video to set the position of the preceding packet to the read offset position at which the reading operation is resumed. A packet having a smaller packet number corresponds to a preceding packet.

The format conversion for the corresponding data is skipped until the position of the late packet is reached (560). For example, in the case where the position of the next packet with respect to the audio precedes the position of the next packet with respect to the video, that is, when the packet number of the next packet with respect to the audio is smaller than the packet number of the next packet with respect to the video, the format conversion operation is performed only for the audio, and the corresponding operation for the video is skipped until the packet number to be read next is reached.

It is possible to prevent and/or reduce problems such as missing necessary data, overwriting on data that has already been replaced, and the like by adjusting the read offset position of the audio and the video when resuming the digital bridge operation after the data replacement.

Upon determining that the format conversion has completed (“YES” in operation 570), the multiplexer 130 combines the format-converted video stream, the format-converted audio stream, and other data streams such as the subtitle stream into one file and outputs it (580).

According to an image processing apparatus and a method for controlling the same according to an example embodiment, in the case where an error is detected in the process of converting the format of data recorded on the disk, the format conversion process does not need to be performed from the beginning again by fetching the data of the section that is not successfully converted due to the error from the server.

Furthermore, using an image processing apparatus and a method for controlling the same according to an example embodiment, it is possible to continuously perform the format conversion process after acquiring data from the server to prevent the digital bridge operation from being performed in duplication with respect to the portion where the data is already acquired by appropriately adjusting the position of a read offset according to the type of an error that has occurred.

Although various example embodiments of the present disclosure have been illustrated and described, it would be appreciated by those skilled in the art that changes may be made in these embodiments without departing from the principles and spirit of the disclosure, the scope of which is defined in the claims and their equivalents.

What is claimed is:

1. An image processing apparatus comprising:
a data reader configured to read original data recorded on a storage medium;
a signal processor configured to extract an audio stream and a video stream from the original data and to convert a format of the extracted audio stream and a format of the extracted video stream into a predetermined format;
a communication module configured to communicate with an external server; and
a controller configured to control, when the data reader detects a read error or when the signal processor detects a demuxing error or a conversion error, the communication module to request the external server for at least one of: format-converted audio data and format-converted video data corresponding to a section in which the read error, the demuxing error, or the conversion error is detected.

2. The image processing apparatus according to claim 1, wherein the signal processor is configured to replace data of a section in which the read error, the demuxing error, or the conversion error is detected with at least one of: the format-converted audio data and the format-converted video data received from the external server.

3. The image processing apparatus according to claim 1, wherein:
the data reader is configured to continue, upon detecting the read error, to read subsequent packets until the data reader finds a packet in which a read error is not detected,
wherein the communication module is configured to receive, upon finding the packet in which a read error is not detected, the format-converted audio data and format-converted video data of the section in which the read error is detected from the external server at once.

4. The image processing apparatus according to claim 2, wherein:
the original data includes at east one transport stream including a plurality of transport stream packets,
wherein the signal processor is configured to detect the conversion error using a Cyclic Redundancy Check (CRC) test.

5. The image processing apparatus according to claim 4, wherein the communication module is configured to receive an audio table in which an audio CRC test command to perform the CRC test and transport stream packets of the original data are matched and a video table in which a video CRC test command to perform the CRC test and transport stream packets of the original data are matched from the external server.

6. The image processing apparatus according to claim 5, wherein the controller is configured to detect the video CRC test command and the audio CRC test command matched with the transport stream packets of a section in which the read error or the demuxing error is detected from the audio table and the video table, and to control the communication module to request the external server for the format-converted audio data corresponding to the detected audio CRC test command and the format-converted video data corresponding to the detected video CRC test command.

7. The image processing apparatus according to claim 6, wherein:
the controller is configured to compare a transport stream packet matched with a next command of the detected video CRC test command and a transport stream packet matched with a next command of the detected audio CRC test command to determine a preceding transport stream packet as a read offset position,
wherein the data reader is configured to resume the reading of the original data from the determined read offset position.

8. The image processing apparatus according to claim 7, wherein the signal processor is configured to skip, upon determining that the transport stream packet matched with the next command of the detected video CRC test command precedes the transport stream packet matched with the next command of the detected audio CRC test command, a format conversion for the audio stream until reaching the transport stream packet matched with the next command of the detected audio CRC test command.

9. The image processing apparatus according to claim 7, wherein the signal processor is configured to skip, upon determining that the transport stream packet matched with the next command of the detected audio CRC test command precedes the transport stream packet matched with the next command of the detected video CRC test command, a format conversion for the video stream until reaching the transport stream packet matched with the next command of the detected video CRC test command.

10. The image processing apparatus according to claim 1, wherein:
the signal processor is configured to output a format-converted audio stream and a format-converted video stream, and further comprises:
a multiplexer configured to generate an output file including the format-converted audio stream and the format-converted video stream.

11. A method of controlling an image processing apparatus, the method comprising:
reading original data stored on a storage medium;
performing demuxing to extract an audio stream and a video stream from the original data;
converting a format of the extracted audio stream and a format of the extracted video stream into a predetermined format; and
receiving, when a read error, a demuxing error, or a conversion error is detected, at least one of: format-converted audio data and format-converted video data corresponding to a section in which the read error, the demuxing error, or the conversion error is detected, from an external server.

12. The method according to claim 11, further comprising:
replacing data of a section in which the read error, the demuxing error, or the conversion error is detected with the format-converted audio data or the format-converted video data received from the external server.

13. The method according to claim 11, further comprising:
continuing, upon detecting the read error, to read subsequent packets until a packet in which a read error is not detected is found; and
receiving, upon finding a packet in which a read error is not detected, the format-converted audio data and format-converted video data of the section in which the read error is detected from the external server at once.

14. The method according to claim 12, wherein:
the original data includes at least one transport stream including a plurality of transport stream packets,
wherein the detecting of the conversion error comprises detecting the conversion error using a Cyclic Redundancy Check (CRC) test.

15. The method according to claim 14, further comprising:
receiving an audio table in which an audio CRC test command to perform the CRC test and transport stream packets of the original data are matched and a video table in which a video CRC test command to perform the CRC test and transport stream packets of the original data are matched from the external server.

16. The method according to claim 15, wherein the receiving of the at least one of: the format-converted audio data and the format-converted video data comprises:
detecting the video CRC test command and the audio CRC test command matched with the transport stream packets of a section in which the read error or the demuxing error is detected from the audio table and the video table; and
receiving the format-converted audio data corresponding to the detected audio CRC test command and the format-converted video data corresponding to the detected video CRC test command from the external server.

17. The method according to claim 16, further comprising:
comparing a transport stream packet matched with a next command of the detected video CRC test command and a transport stream packet matched with a next command of the detected audio CRC test command to determine a preceding transport stream packet as a read offset position; and
resuming reading of the original data from the determined read offset position.

18. The method according to claim 17, further comprising:
performing, upon determining that the transport stream packet matched with the next command of the detected video CRC test command precedes the transport stream packet matched with the next command of the detected audio CRC test command, a format conversion for the video stream and skipping the format conversion for the audio stream until reaching the transport stream packet matched with the next command of the detected audio CRC test command.

19. The method according to claim 17, further comprising:
performing, upon determining that the transport stream packet matched with the next command of the detected audio CRC test command precedes the transport stream packet matched with the next command of the detected video CRC test command, a format conversion for the audio stream and skipping the format conversion for the video stream until reaching the transport stream packet matched with the next command of the detected video CRC test command.

20. The method according to claim 11, further comprising:
generating an output file including the format-converted audio stream and the format-converted video stream.
